(19) United States
(12) Patent Application Publication
(10) Pub. No.: US 2008/0056125 A1
(43) Pub. Date: Mar. 6, 2008

(54) CONGESTION CONTROL IN A WIRELESS NETWORK

(75) Inventors: Jarkko Kneckt, Espoo (FI); Carl Simon Wijting, Helsinki (FI)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation, Espoo (FI)

(21) Appl. No.: 11/470,622

(22) Filed: Sep. 6, 2006

(51) Int. Cl. H04L 12/26

(52) U.S. Cl. 370/229

(57) ABSTRACT

Various embodiments are disclosed relating to congestion control in wireless networks. In an example embodiment, one or more trigger conditions may be determined relating to traffic congestion for one or more performance levels in a wireless network. One or more congestion control actions may be associated with each of the one or more performance levels. When a trigger condition at a wireless node is met, the associated congestion control actions may be performed.

### BACKGROUND

The rapid diffusion of wireless mesh network access and the increasing demand for wireless data coverage is driving the installation of a very large number of wireless nodes (e.g., such as mesh points (MPs) or Access Points (APs)). A wireless mesh network may be considered to be a collection of MPs that are interconnected using wireless communication links. Each MP may typically be an Access Point, but may also be a station or other wireless node. Data transmission and receive resources of such MPs are shared resources.

As data traffic in wireless networks increases, traffic congestion may occur. Due to the shared nature of the wireless resources in a wireless network, data traffic congestion may not, at least in some cases, be adequately addressed by conventional data network congestion control techniques alone, such as a reliance upon different Access Categories (ACs) or traffic priorities to prioritize different types of traffic.

A draft specification from the IEEE 802.11s Task Group has proposed the use of three “mesh action” frames (i.e., “Congestion Control Request”, “Congestion Control Response”, and “Neighborhood Congestion Announcement”) for use in congestion control in mesh networks. The 802.11s proposal is, however, inadequate as it does not address how congestion is recognized or what actions to take in response to various types of congestion.

### SUMMARY

The following embodiments and aspects thereof are described and illustrated in conjunction with systems, tools and methods which are given by way of example and meant to be illustrative, not limiting in scope. In various embodiments, one or more of the above-described problems may be reduced or eliminated, while other embodiments may be directed to other improvements. Also, as described in greater detail, the various embodiments described herein may be applicable to a wide variety of wireless networks, including mesh networks, cellular networks, wireless LAN (WLAN) networks, and other types of wireless networks. The description of a mesh network herein is only an illustrative example embodiment, and the techniques described herein may be applied to other wireless networks.

According to an example embodiment, a method for congestion control may include determining one or more trigger conditions relating to traffic congestion for one or more performance levels in a wireless network and associating one or more congestion control actions with each of the one or more performance levels. Performance levels may also be referred to herein as performance states, or states. These terms, for purposes of this disclosure, should be considered to be interchangeable. The example method may further include making a determination that one or more of the trigger conditions for a given one of the performance levels (states) has been met at a wireless node and, responsive to the determination, performing at least one of the one or more congestion control actions associated with the given performance level.

According to another example embodiment, an apparatus may include a controller, a memory coupled to the controller and a wireless transceiver coupled to the controller. The example apparatus may be adapted to receive a message, where the message defines one or more trigger conditions relating to traffic congestion for one or more performance levels. Further, the message may also associate one or more congestion control actions with each of the one or more performance levels. In an example embodiment, the apparatus may be a first wireless node and a second wireless node may generate the message. The message may then be provided to the first wireless node by the second wireless node over a wireless communication link. The apparatus (e.g., first wireless node) may then determine that one or more of the trigger conditions for a given one of the performance levels has been met at the apparatus and, responsive to the determination, perform at least one of the one or more congestion control actions associated with the given performance level in the message.

In yet another example embodiment, a wireless network may include a plurality of communicatively coupled wireless nodes, wherein a first wireless node of the plurality of wireless nodes is adapted to provide a message to a second wireless node of the plurality of wireless nodes. In the example embodiment, the message may include one or more trigger conditions relating to traffic congestion for one or more performance levels in the wireless network. The message may also include associations of one or more congestion control actions with each of the one or more performance levels. In the example wireless network, the second wireless node may then, using information in the message, determine that one or more of the trigger conditions for a given one of the performance levels has been met. Responsive to this determination, the second wireless node, in correspondence with the message, may perform at least one of the one or more congestion control actions associated with the given performance level.

### BRIEF DESCRIPTION OF THE DRAWINGS

Example embodiments are illustrated in referenced figures of the drawings. It is intended that the embodiments and figures disclosed herein are to be considered illustrative rather than restrictive.

FIG. 1 is a diagram illustrating a wireless mesh network according to an example embodiment;

FIG. 2 is a state diagram illustrating an approach for congestion control according to an example embodiment;

FIG. 3 is a flowchart illustrating a method for congestion control according to an example embodiment;

FIG. 4A is a diagram illustrating a congestion control frame according to an example embodiment;

FIG. 4B is a diagram illustrating trigger conditions and congestion control actions performed at a wireless node according to another example embodiment;

FIG. 5 is a table illustrating access categories (e.g. traffic priorities) for different types of data that may be communicated in a wireless network; and

FIG. 6 is a block diagram illustrating a wireless node according to an example embodiment.

### DETAILED DESCRIPTION

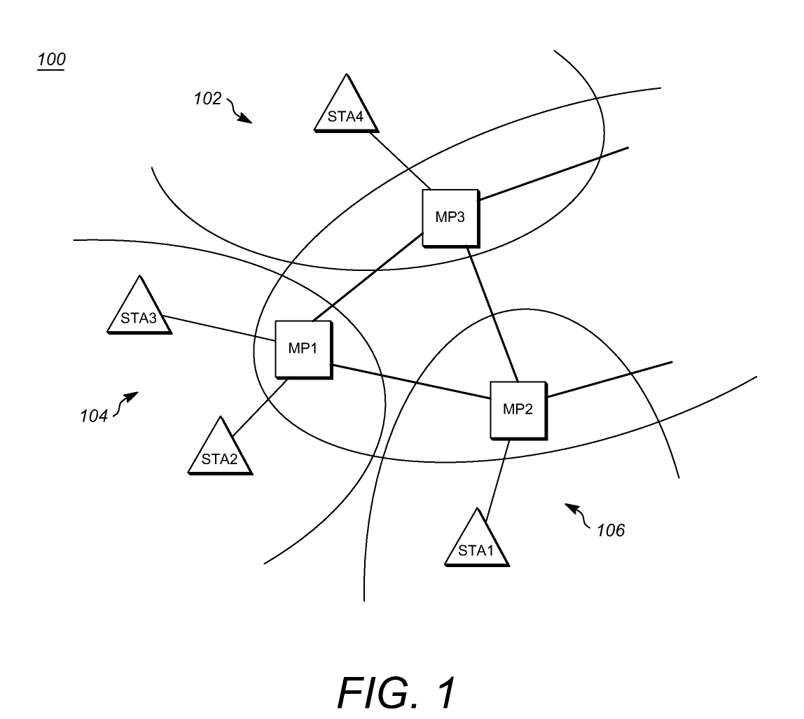

Referring to the Figures in which like numerals indicate like elements, FIG. 1 is a diagram illustrating a wireless mesh network 100 according to an example embodiment.

According to such an example embodiment, a wireless mesh network may be a collection of mesh points (MPs) interconnected with wireless communication links. Each MP may typically be an Access Point, but may also be a station or other wireless node. For example, a wireless mesh network may employ either a full mesh topology or a partial mesh topology. In a full mesh topology, each node (or mesh point) may be connected directly to each of the other MPs via a wireless link. In a partial mesh topology, the mesh points may be connected to some but not necessarily all of the other mesh points in the mesh network.

In the example wireless mesh network 100 illustrated in FIG. 1, mesh points MP1, MP2 and MP3 may be inter-connected via wired or wireless links. Also, each mesh point (MP) may be coupled to one or more wireless stations in its local cell. For example, MP1 is located in cell 104 and is connected via wireless links to stations STA2 and STA3 within cell 104. MP2 is located in cell 106 and is connected via a wireless link to station STA1. MP3 is located in cell 102 and may be connected via a wireless link to station STA4. Network 100 (including MP1, MP2 and MP3) may be considered a wireless distribution system. Wireless mesh network 100 is merely an example network and the disclosure is not limited thereto.

In an example wireless mesh network, each MP may be capable of many-to-many connections, and may be capable of learning network topology, dynamic path configuration, and other network capabilities, although the disclosure is not limited thereto. Each MP may also be mobile or be capable of being moved or movable, and may be capable of dynamically reconfiguring itself, although the disclosure is not limited thereto.

The various embodiments described herein may be applicable to a wide variety of networks and technologies, such as WLAN networks (e.g., IEEE 802.11 type networks), IEEE 802.16 WiMAX networks, WiMedia networks, Ultra Wide Band networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example.

The term “wireless node” or “node,” or the like, may include, for example, a wireless station, such as a mobile station or subscriber station, an access point (AP) or base station, a relay station, a wireless personal digital assistant (PDA), a cell phone, an 802.11 WLAN phone, a WiMedia device, a WiMAX device, a wireless mesh point (MP), or any other wireless device. These are merely a few examples of the wireless devices and technologies that may be used to implement the various embodiments described herein, and this disclosure is not limited thereto.

As noted above, data transmission and receive resources of the MPs in the mesh network are typically shared resources. For instance, in the mesh network 100, MP3 may share its data transmission and/or receive resources for data communication to/from STA4, MP1 and MP2. This is merely an example embodiment and MP3 may communicate with any number of other wireless nodes, between amongst which its data transmission and/or receive resources would be shared. In such a situation, each wireless node with which MP3 communicates may be allocated a certain portion (e.g., time slot) of the data transmission and/or receive resources of MP3. If one of the wireless nodes that MP3 is in communication with “floods” MP3 with data packets (e.g., sends a large amount of data in a short period of time), MP3 may be unable to adequately process data traffic from that station and the other stations with which it communicates. In such a situation, MP3 may be considered to be congested.

When a wireless node, such as MP3 in this example, becomes congested, such congestion may result in (i) data packets being dropped (which may result in the dropped packets being resent, thus further increasing congestion), (ii) increased delay in packet delivery, and (iii) an increase in a number of packet errors (e.g., consecutive errors and/or average number of errors) for data communicated through MP3, among any number of other situations. Such effects may degrade the performance of the mesh network 100 and thus reduce the quality of the user experience when accessing such a mesh network. Such congestion at MP3 may also prevent MP3 from processing packets from other wireless nodes, which may therefore, create a bottle neck.

As was discussed above, a draft specification from the IEEE 802.11s Task Force has proposed the use of three “mesh action” frames (i.e., “Congestion Control Request”, “Congestion Control Response”, and “Neighborhood Congestion Announcement”) for use in congestion control in mesh networks. As was also noted above, the 802.11s proposal is inadequate as it does not specifically address how congestion is recognized or what actions are to be taken in response to various types of congestion.

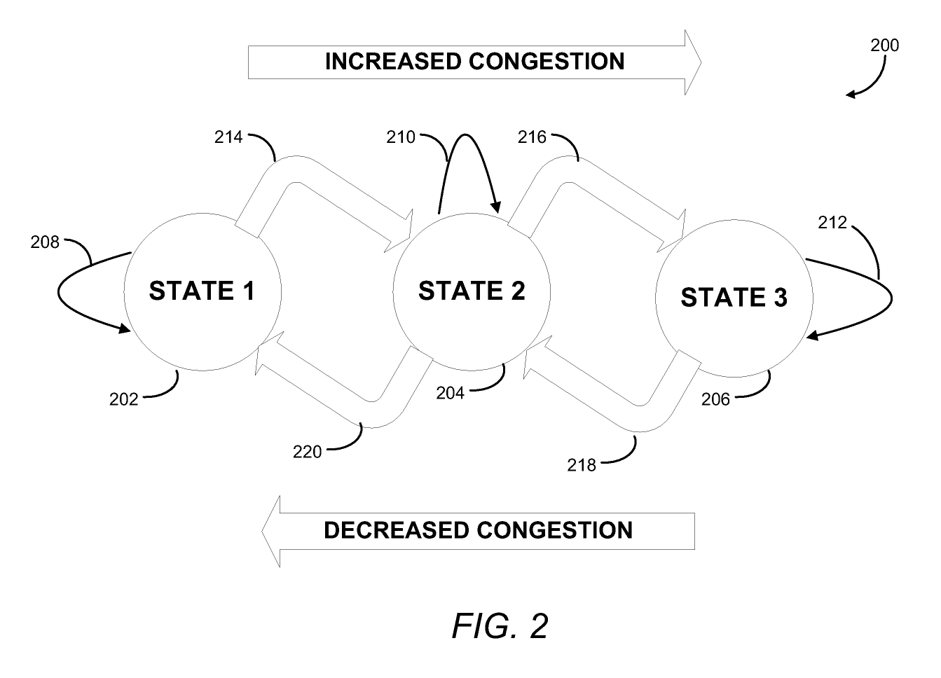

FIG. 2 is a state diagram 200 that illustrates an example approach that may be used for congestion control in a wireless network (such as in a wireless mesh network or other wireless network). The state diagram 200, for this example, illustrates the operation of a single wireless node in a mesh network, such as MP3 of the mesh network 100 described above. The state diagram 200 illustrates three performance levels (states) 202, 204 and 208 for the given wireless node. Of course, additional or fewer performance states may exist and the exact number of states depends on the particular embodiment. The state diagram 200 is merely an example embodiment, and other embodiments may be used.

In the state diagram 200, as shown in FIG. 2, moving left to right represents increasing levels of data congestion in the wireless node and/or network. Accordingly, as also indicated in FIG. 2, moving right to left in the state diagram 200 represents decreasing levels of congestion. The three performance levels 202, 204 and 208 are designated “STATE 1”, “STATE 2” and “STATE 3.” For the sake of clarity and consistency, however, these performance levels (states) will be referred to, respectively, as performance level 202, performance level 204 and performance level 206.

For the state diagram 200, the performance level 202 may be considered to be representative of the wireless node operating with little or no data traffic congestion. The performance level 204 may be considered to be representative of the wireless node operating with a moderate level of data traffic congestion. The performance level 206 may be considered to be representative of the wireless node operating with heavy data traffic congestion. The particular state that the wireless node is operating in may be determined based on one or more performance parameters. These parameters may include Quality of Service (QoS) parameters, as defined, for example, in the 802.11 family of specifications. Of course, performance parameters other than QoS parameters (metrics) may be used. Such trigger conditions may include, without limitation, an average packet delay, a number of dropped packets, a number of consecutive frames lost and an average frame loss rate, among any number of other performance parameters or metrics.

As one example, an average packet error rate for the wireless node may be used to determine the performance level at which the wireless node is operating. For instance, if the average packet error rate for the wireless node is below a first threshold, this may indicate that the wireless node is operating at the performance level 202 (e.g., little to no congestion). If the average packet error rate is above the first threshold but below a second threshold, this may indicate that the wireless node is operating at the performance level 204 (e.g., moderate congestion). If the average packet error rate is above the second threshold, this may indicate that the wireless node is operating at the performance level 206 (e.g., heavily congested). It will be appreciated that average packet error rate is only one example of a parameter that may be used to determine a performance level for a wireless node. In an example embodiment, additional or other parameters (such as those described above and/or those defined in the 802.11 family of specifications) may be used individually or in conjunction with one another to determine a performance level for a given wireless node.

As illustrated in FIG. 2, when the example wireless node is operating at a particular performance level, the wireless node may periodically (e.g., continually) monitor the performance parameters that the wireless node uses to determine its performance level. For instance, if the wireless node is operating at the performance level 202, the arrow 208 illustrates this monitoring. Likewise, if the wireless node is operating in the performance level 204 or 206, the arrows 210 and 212 respectively illustrate performance parameter monitoring. Such monitoring may be accomplished in a similar fashion to the monitoring of QoS parameters for use in triggered QoS measurement reports, such as described in the 802.11k specification.

In the state diagram 200, the block arrows 214, 216, 218 and 220 indicate transitions of the wireless node from one performance level to another performance level. For instance, for increasing levels of congestion, the block arrow 214 illustrates the transition of the wireless node from the performance level 202 (e.g., little or no congestion) to the performance level 204 (e.g., moderate congestion). Similarly, the block arrow 216 illustrates the transition of the wireless node from the performance level 204 (e.g., moderate congestion) to the performance level 206 (e.g., heavy congestion).

In like fashion, for decreasing levels of congestion, the block arrow 218 illustrates the transition of the wireless node from the performance level 206 (e.g., heavily congested) to the performance level 204 (e.g., moderate congestion). Similarly, the block arrow 220 illustrates the transition of the wireless node from the performance level 204 (e.g., moderate congestion) to the performance level 202 (e.g., little or no congestion).

In an example embodiment, one or more trigger conditions relating to data traffic congestion may be determined for the performance levels 202, 204 and 206 shown in FIG. 2. As discussed above, these performance levels may represent performance levels of an MP operating in a wireless mesh network. Also in the example embodiment, one or more congestion control actions may be associated with each of the one or more performance levels. For instance, in the example embodiment of FIG. 2, the trigger conditions may correspond with the one or more performance parameters being monitored at 209, 210 and 212. For instance, using the example of average packet error rate described above (as an example QoS parameter), a first trigger condition for performance level 202 may be the average packet error rate for the wireless node exceeding the first threshold value. In this situation, the wireless node would monitor the average packet error rate at 208 to determine that the average packet error rate has exceeded the first threshold.

For this example, in response to the determination that the average packet error rate has exceeded the first threshold, the wireless node may transition from the performance level 202 to the performance level 204, as indicated by block arrow 214. Also at block arrow 214, the wireless node may perform one or more of the congestion control actions associated with the performance level 202 in response to the trigger condition being met. As was indicated above, the example of average packet error rate is given by way of example.

Depending on the particular embodiment, any number of trigger conditions may be used to determine a particular performance level for a wireless node. Likewise, any number of congestion control actions may be associated with those trigger conditions. Such congestion control actions may include, but are not limited, to (i) the wireless node sending a QoS measurement report (e.g., as described 802.11k) to one or more other wireless nodes or MPs in the network (such as to one or more upstream nodes or nodes closer to the fixed network), where the QoS measurement report may include values for the monitored performance parameters, (ii) the wireless node sending a “congestion control request” in accordance with the 802.11s draft specification (e.g., to an upstream mesh point), (iii) the wireless node implementing (or instruction another wireless node to implement) local rate control, (iv) the wireless node initiating a route discovery process to determine if an alternative data path with less congestion may be available in the mesh network, (v) the wireless node sending a “neighborhood congestion announcement” to notify other nodes of the congested traffic congestion at this node, e.g., in accordance with the 802.11s draft specification, (vi) the wireless node implementing (or instructing another wireless node or nodes to implement) Enhanced Distributed Channel Access (EDCA) QoS parameters (e.g., such as those described in the 802.11e that specify use of different parameters for different Access Categories or QoS parameters) specification or adjusting or modifying such EDCA parameters for such wireless nodes, and (vii) stopping transmission and/or dropping received packets without forwarding such packets, for one of more types of data traffic (e.g., for one or more Access Categories or traffic priorities) or for traffic from one or more wireless nodes. Of course, these congestion control actions are merely examples and any number of other appropriate actions may be taken in response to a particular trigger condition being met.

In the example embodiment illustrated by the state diagram 200 in FIG. 2, a first set of trigger conditions may be implemented for increasing levels of congestion, while a second set of trigger conditions may be implemented for decreasing levels of congestions. Likewise, a first set of congestion control actions may be associated with the first set of trigger conditions for increasing levels of congestion, while a second set of congestion control actions may be associated with the second set of trigger conditions for decreasing levels of congestion. Such an approach allows for “hysteresis” between performance levels so that slight changes in the amount of data traffic congestion do not result in repeated congestion control actions being performed by a wireless node.

However, in another example embodiment, one set of trigger conditions may be implemented for both increasing and decreasing levels of congestion. This may provide a simpler implementation, but may not in some cases offer some of the advantages (e.g., improved stability) provided by a hysteresis technique that may use different trigger conditions for increasing and decreasing levels of congestion.

Referring again to the average packet error rate example discussed above and the state diagram 200, such hysteresis may be implemented as follows. A first set of trigger conditions may be used for increasing levels of congestion. This first set of trigger conditions may include a first average packet error rate threshold of one “1” as a trigger condition to transition from the performance level 202 to the performance level 204 and a second average packet error rate threshold of two “2” to transition from the performance level 204 to the performance level 206. The number two or “2” is merely an example, and may be a packet error rate that is twice as much as the packet error rate to transition from level 202 to level 204.

In this example, a second set of trigger conditions may be used for decreasing levels of congestion. This second set of trigger conditions may include a third average packet error rate threshold of one and three-quarters “1.75” as a trigger condition to transition from the performance level 206 to the performance level 204 and a fourth average packet error rate threshold of three-quarters “0.75” as a trigger condition to transition from the performance level 204 to the performance level 202. These are merely example numbers or packet error rates, and any numbers or trigger conditions may be used.

In such an implementation, the difference between the first threshold and the fourth threshold may result in hysteresis between the performance level 202 and the performance level 204, while the difference between the second threshold and the third threshold results in hysteresis between the performance level 204 and the performance level 206, which may improve performance and/stability of the system in some cases. Accordingly, for this example, slight variations in average packet error rate around one of the thresholds will not result in repeated congestion control actions being performed. In such a situation, the trigger conditions for the performance level 204, for example, may be based on the previous performance level (e.g., whether congestion is increasing or decreasing).

Likewise, a first set of congestion control actions may be associated with the trigger conditions for increasing levels of congestion, while a second set of congestion control actions may be associated with the trigger conditions for decreasing levels of congestion. For instance, the congestion control actions associated with the trigger conditions for increasing levels of congestion may be, for example, implementing local rate control or stopping transmission of certain types of data. In contrast, the congestion control actions for decreasing levels of congestion may be, for example, ceasing local rate control, adjusting QoS (or EDCA) parameters for one or more other nodes or types of traffic, or resuming transmission of certain types of data.

In an example embodiment, trigger conditions and congestion control actions may be specified or implemented for each AC (Access Category), or on a per-AC basis. This may allow nodes to respond differently to different types of traffic or congestion conditions for different ACs (or traffic priorities). For example, lower priority traffic or ACs may be impacted first by congestion, whereas the higher priority ACs may not have significant performance degradation until congestion reaches a higher level, for example. Thus, by implementing trigger conditions and congestion control actions for each AC or traffic priority, QoS reports, congestion control reports, and other congestion control actions may be performed or specified for different ACs.

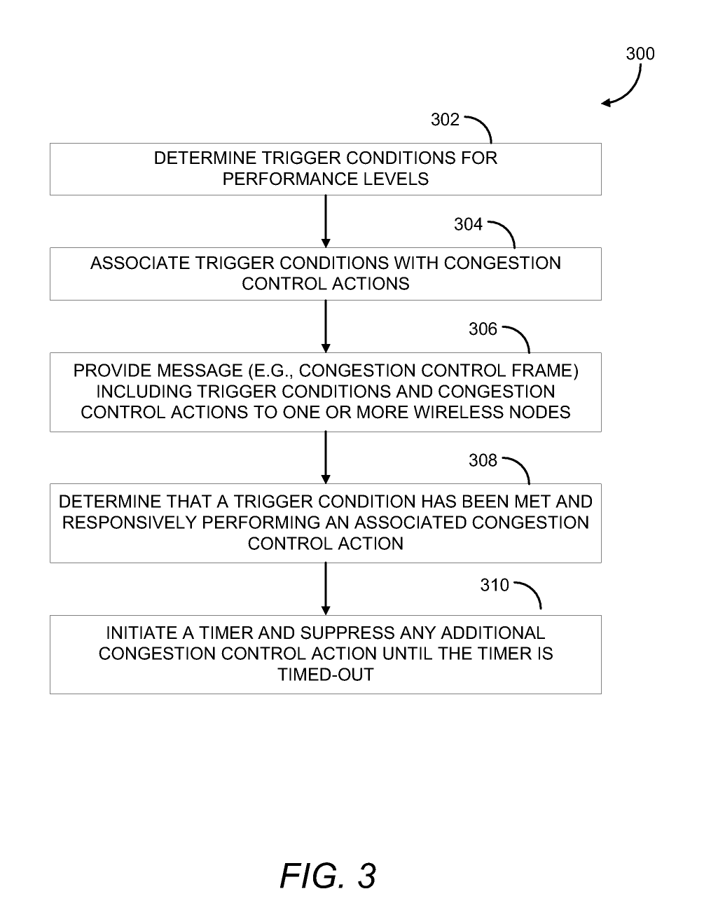

FIG. 3 is a flowchart illustrating a method 300 for congestion control according to an example embodiment. The method 300 includes, at block 302, determining one or more trigger conditions relating to traffic congestion for one or more performance levels in a wireless network, such as was discussed above with respect to FIG. 2. The method 300 further includes, at block 304, associating one or more congestion control actions with each of the one or more performance levels, such as was also previously described. In the method 300, the determining of block 302 and the associating of block 304 may be performed at a first wireless node (e.g., MP).

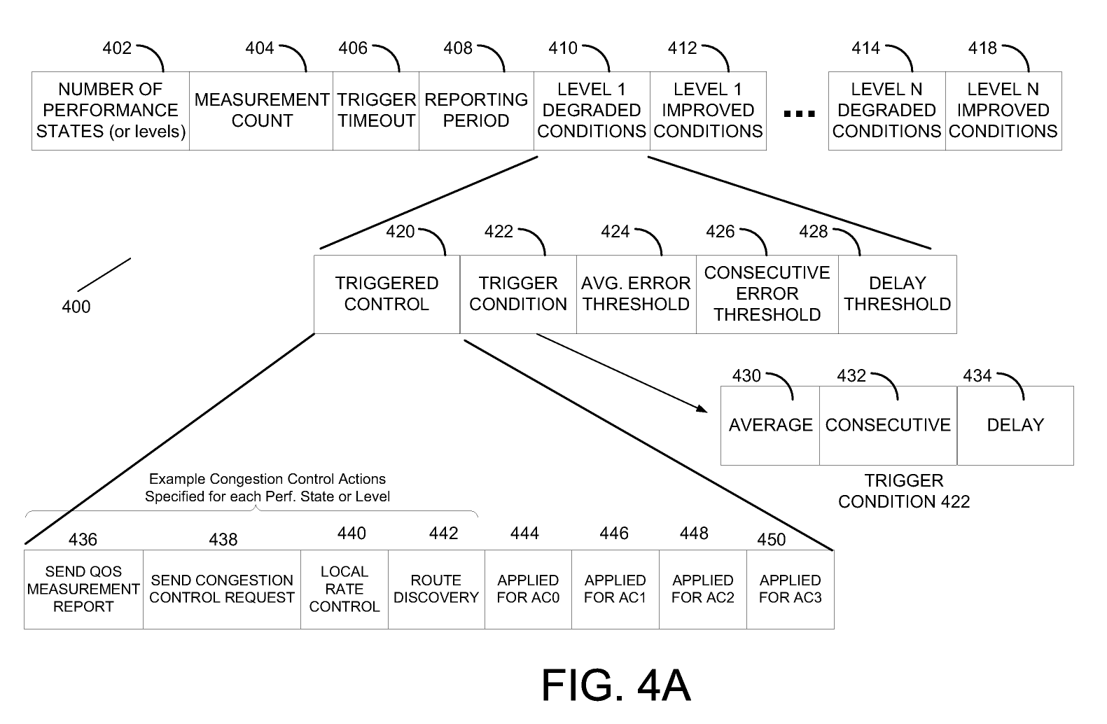

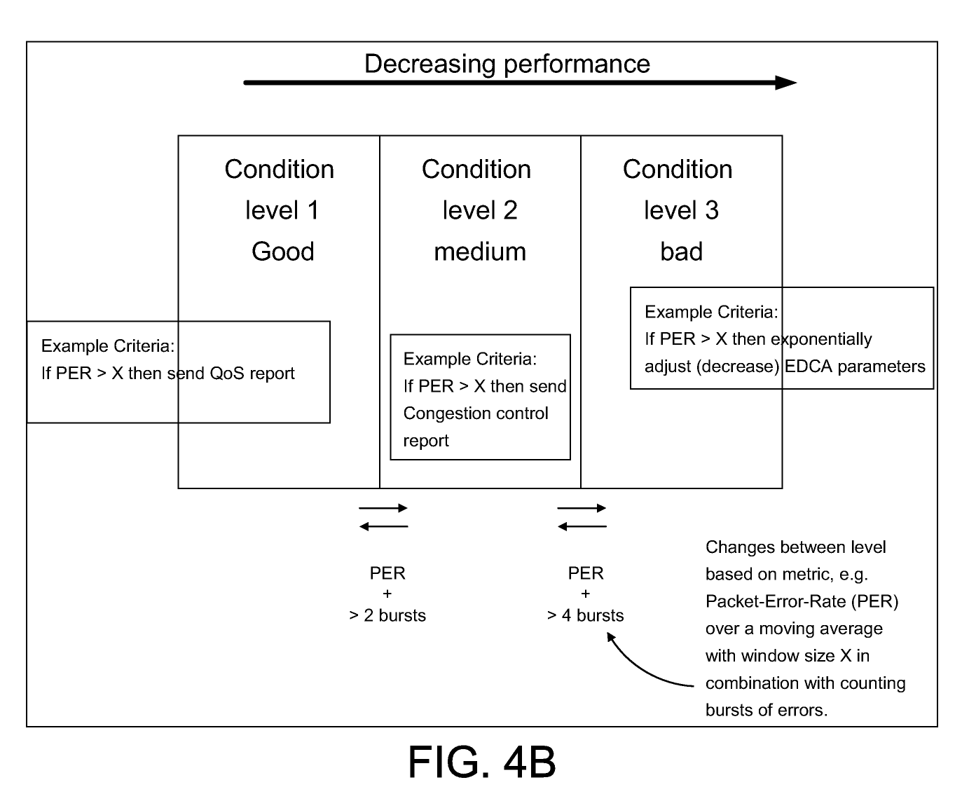

Still further in the method 300, at block 306, the trigger conditions and the associated congestion control actions may be included in a message by the first wireless node and the message provided to one or more other wireless nodes (e.g., MPs). Such a message may be referred to as a congestion control frame. An example embodiment of a congestion control frame is described below with respect to FIG. 4A.

The method 300, at block 308, further includes determining that one or more of the trigger conditions for a given one of the performance levels has been met at a wireless node and responsively performing at least one of the one or more congestion control actions associated with the given performance level, such as was discussed in further detail above.

As an alternative to the technique described above for implementing hysteresis between performance levels, the method 300 includes, at block 310, initiating a timer in response to the determination that a trigger condition has been met. In the method 300 (at block 310) additional congestion control actions are suppressed until the timer has timed-out. Such an approach, as with hysteresis, may prevent repeated congestion control actions in the event a wireless node operates in a state where a performance parameter being used as a trigger condition varies around the trigger condition threshold for a period time.

FIG. 4A illustrates an example embodiment of a message, which may be referred to as a congestion control frame 400 (frame 400). The frame 400, as discussed above, may be used to provide one or more wireless nodes (e.g., MPs) in a wireless mesh network with trigger conditions and congestion control actions associated with those trigger conditions. In an example embodiment, the trigger conditions are determined, and the congestion control actions are associated with those trigger conditions by another wireless node (MP) in the wireless mesh network, such as by one MP or AP within a network. Such an approach may be used to ensure that all MPs in a given network operate using the same trigger conditions and congestion control actions, for example. It may be advantageous for all the MPs in a given wireless mesh network to operate using the same trigger conditions and associated congestion control actions in order to ensure compatibility between the MPs and proper operation of the wireless mesh network. Such an approach may in some cases provide a more consistent approach by different nodes (e.g., MPs, APs) within a network to addressing or responding to various traffic congestion conditions. As an alternative to using the frame 400, the trigger conditions and associated congestion control actions could be provided or specified to the MPs of a wireless mesh network using a beacon signal from one or more MPs or APs. Such beacon signals are known and are described in the 802.11 family of specifications.

As shown in FIG. 4A, the frame 400 may include multiple fields, e.g., to set up a triggered recognition mechanism in a network. The fields may, for example, include a list of conditions for different congestion levels and actions for different congestion levels. One set of trigger conditions and congestion control actions may be provided for both increasing and decreasing levels of congestion. Alternatively, different sets of trigger conditions and congestion control actions may be provided for increasing congestion (e.g., degraded conditions) and decreasing congestion (e.g., improved conditions).

Some of the example fields of frame 400 will be briefly described, according to an example embodiment. The following provides some brief examples of the types of fields that may be included according to an example embodiment. For instance, the frame 400 may include a “number of performance states” field 402 to indicate the number of performance states (or performance levels). For example, in FIG. 2, there are three performance states (e.g., state 1, state 2 and state 3), although any number of states may be used.

Frame 400 may also include a “measurement count” field 404, and may indicate a number of packets (or frames), and may indicate a number of packets or frames over which a QoS measurement (such as packet error rate) is measured. A “trigger timeout” field 406 may indicate a time period after which a node should not generate further QoS metrics (or measurement) reports (e.g., specifying a delay before generating a further QoS report or QoS metrics/measurement report). A “reporting period field” (which may also be referred to as a periodicity of reporting field) 405 may contain a value in units of beacon periods at which a node (e.g., MP or AP) should transmit its QoS measurement report or its Performance Level. Thus, for example, one measurement report may be reported every X beacon periods, where field 405 may identify X or may identify the number of beacon periods between reports. In an example embodiment, the measurement reports may be reported in separate management frames. These management frames may be aggregated together with the transmitted data frames, for instance using 802.11n A-MPDU aggregation mechanism (aggregated MPDU or aggregated protocol data units or packets), for example. Thus, the measurement reports may be distributed by unicast transmissions together with actual data payload. Similarly multicast delivery may be used to deliver or transmit measurement reports in another example embodiment (e.g., as a multicast transmission).

The frame 404 may also include a degraded conditions field (e.g., for increased congestion) and an improved conditions field (e.g., for decreased congestion) for each performance level (or performance state) for wireless nodes in a particular wireless mesh network, if different trigger conditions and congestion control action are used for increasing and decreasing congestion. Thus, for each performance state or level, a pair or conditions fields may be provided, according to an example embodiment, such as a Level X degraded conditions fields and a Level X improved conditions field. For example, as shown in FIG. 4A, the frame 400 may include a “level 1 degraded conditions” field 410, a “level 1 improved conditions” field 412, a “level 2 degraded conditions” field (not shown), a “level 2 improved conditions” field (not shown), . . . a “level N degraded conditions” field 414 and a “level N improved conditions” field 416, wherein “N” may indicate the number of performance states or levels for the MPs in a given wireless mesh network. Alternatively, a single conditions field may be used for each of the performance state or levels (e.g., one conditions field for each performance state/level for both increasing and decreasing congestion).

For the frame 400, each of the degraded and improved conditions fields (e.g., fields 410, 412, 414, 418) may include a number of sub-fields, according to an example embodiment. These sub-fields may, for example, include a triggered control field 420, which may identify one or more congestion control actions associated with the performance state or level (e.g., one or more congestion control actions that should or may be performed when an AP or MP transitions to the associated performance state or level). The triggered control field 420 may also identify one or more Access Categories (ACs) for which the congestion control actions may apply, for example.

Fields 422, 424, 426, and 428 relate to the trigger conditions for the performance state or level. The average error threshold field 424 identifies an average error threshold; consecutive error threshold field 426 may identify a consecutive error threshold; and delay threshold field 428 may identify a delay threshold.

The trigger condition field 422 may identify further information related to trigger conditions, including fields 430, 432 and 434, as examples. The following provides some brief examples of the types of fields that may be included according to an example embodiment. An average field 430 may be set (e.g., to 1) to request that a triggered congestion control action be performed when the number of frames or packets for the AC that are discarded over the moving average number of transmitted frames or packets specified in Measurement Count field 404 is equal to the value given in Average Error Threshold field 424. In an example embodiment, discarded frames or packets due to retries may be counted, for example. A consecutive field 432 may be set (e.g., to 1) to request that a triggered congestion control action be performed when the number of frames or packets for the AC that are discarded in succession is equal to the value given in Consecutive Error threshold field 426. A Delay field 434 may be set (e.g., to 1) to request that a triggered congestion control action be performed or generated when the number of consecutive frames or packets for the AC that experience a transmit delay greater than or equal to the value given in the Delay Threshold field 428 (or experience a transmit delay greater than or equal to a lower bound).

The triggered control field 420 may include a number of sub-fields, which will be briefly described according to an example embodiment. Fields 436, 438, 440, and 442 may identify some example congestion control actions that may (or should) be performed for the performance state or level (e.g., when the specified trigger condition(s) is met for the associated performance level). For example, the “Send QoS Measurement Report” field 436 may be set to 1 to request the node to send a QoS measurement report. In an example embodiment, the QoS measurement report may be sent for all ACs that have met at least one trigger condition. The QoS measurement report may be used to inform neighboring nodes of traffic conditions or congestion conditions for the reporting node. The “send congestion control request” field 438 may be set to 1 to request the node or MP to request a congestion control. Local rate control field 440 may be set to 1 to request the node or MP to perform local rate control. Route discovery field 442 may be set to 1 to request the node or MP to perform route discovery to reroute traffic. It will be appreciated that additional fields and/or sub-fields may be included or certain fields and/or sub-fields eliminated in the frame 404.

FIG. 4B is a diagram illustrating trigger conditions and congestion control actions performed at a wireless node according to another example embodiment. Three different performance levels (or conditions) are shown—including level 1 (good performance), level 2 (medium performance) and level 3 (bad performance), e.g., based on varying congestion. If level 1 trigger condition is met (e.g., if packet error rate or PER>X), then a congestion control action is performed, including sending a QoS report. If level 2 trigger condition is met (e.g., PER>X for 2 or more bursts of packets), then a Congestion control report is sent. If level 3 trigger condition is met (e.g., PER>X for 4 or more packet bursts), then EDCA parameters may be adjusted at this node or MP, for example. A different PER threshold may alternatively be used for each level. This may provide a trigger condition based on a changing parameter or metric (e.g., PER) over a moving average with window size X in combination with counting bursts of errors or number of errors.

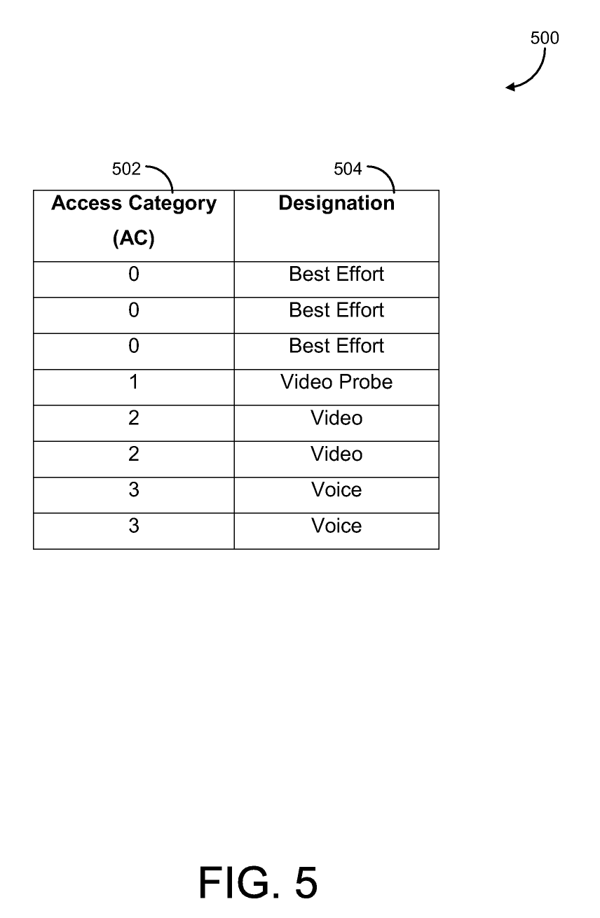

In an example embodiment, the determination of trigger conditions for congestion control in a wireless mesh network and association of congestion control actions with those trigger conditions may be performed for each of a plurality of traffic priorities or Access Categories (ACs). One example of such traffic priorities is illustrated in FIG. 5 by a table 500. The table 500 includes a first column 502, which defines access categories (AC) (traffic priorities) 0, 1, 2 and 3, where AC 3 is the highest priority traffic. The table 500 also includes a second column 504 which includes designations of traffic types for each access category listed in column 502. As was discussed above, one type of congestion control action may be to stop the transmission of certain types of data. One possible implementation of such an approach is to stop the transmission of lower priority (lower access category) traffic.

For instance, referring again to FIG. 2, as data traffic congestion in a wireless node (and/or network) increases, a trigger condition may be met that results in a wireless node transitioning from operating at the performance level 202 (e.g., little or no congestion) to the performance level 204 (e.g., moderate congestion). Responsive to this trigger condition, a congestion control action may be taken where the wireless node stops transmission (or instructs one or more other wireless nodes to stop transmitting) access category ‘0’ traffic. Likewise, were a trigger condition met that resulted in the wireless node transitioning from the performance level 204 to the performance level 206 (e.g., heavily congested), the associated congestion control action may be to only transmit the highest priority traffic (e.g., access category 3 traffic. It will be appreciated that other techniques for establishing traffic priorities are possible. For example, user defined priorities may be used or, as another example, such user priorities may be mapped to the access categories illustrated in FIG. 5.

According to an example embodiment, recognition of congestion or a trigger condition may be used to notice changes in a capability of a node to deliver traffic, for example. The congestion may be caused by a broken link between nodes or MPs an increase in amount of offered traffic, or other reason. The degraded quality, according to an example embodiment, may be detected by an increase in discarded frames and increased transmission delay, change in packet error rate (PER), or a change in other parameter or criteria.

In an example embodiment, initial or minor changes in network congestion may be recognized or detected, e.g., in an early stage, and steps or actions may be taken to address the congestion before the congestion becomes chronic or severe. In an example embodiment, nodes may, via a request for a triggered QoS measurement report, may continually measure one or more QoS performance parameters and send out a QoS report if the triggered condition is met, for example. Other actions may be taken as well.

In an example embodiment, triggered QoS measurements may be used to set up background QoS measurements for non-AP stations or nodes, for example. The triggered measurements may define measurements, and may also specify trigger conditions for measurement report transmission. The QoS metric (or QoS measurements) report may be transmitted if the triggered condition is met. In an example embodiment, the triggered measurements or other actions may specify trigger conditions for average transmission delay, consecutive frame loss and average frame loss, for example.

According to an example embodiment, the triggered congestion recognition mechanism may be based upon or built upon triggered QoS measurements. The congestion recognition mechanism defines one or more (e.g., 1-4) trigger conditions for degraded and improved performance. If any of degraded performance conditions (trigger conditions) is met the performance is considered to be degraded and the specified congestion control action is typically performed. The performance is considered to be improved if all specified conditions are met, according to an example embodiment.

In an example embodiment, a requesting node or AP or MP may send a request to one or more other nodes or stations, specifying thresholds that may trigger the transmission of a QoS measurements report to the requesting node. For example, one or more stations or nodes may monitor one or more QoS metrics, such as packet error rate, number or percentage of discarded frames, average transmit delay, and then may send a QoS measurement report to one or more other nodes, such as one or more upstream nodes (e.g., nodes closer to a fixed network). In addition, since a node or MP may already be tracking or monitoring one or more local QoS metrics (pursuant to the requested triggered QoS measurement report), such node may therefore, easily detect when one or more trigger thresholds are met.

In an example embodiment, transmission of such triggered QoS measurement reports to one or more other nodes may allow a network management function with a network to collect statistics regarding the performance of the network. One or more nodes or MPs (e.g., a central control MP) may then use these performance statistics to update or change the values used for trigger conditions and/or congestion control actions.

In another example embodiment, a logical combination of the specified trigger conditions may be used, such as a logical ORing, or ANDing of multiple conditions to provide a specified trigger condition for a performance state or level. Although not shown in FIG. 4A, a “logical combination” field (one or more bits) in frame 400 may specify whether multiple conditions should be logically ORed or ANDed to provide or determine the trigger condition. In an example embodiment, the logical combination field may be included as another sub-field within trigger condition field 422. FIG. 4B shows an example use of a logical combination of trigger conditions, such as the PER and the number of sequences of consecutive lost frames (bursts), according to an example embodiment.

If the trigger condition is met, the node or MP may perform the one or more associated congestion control actions, e.g., for congestion mitigation or recovery. The actions may include transmission of QoS measurement report, congestion control request or neighborhood congestion control announcement, or trigger to set EDCA parameters according to local rate control mechanism, drop packets, perform or adjust access control for one or more ACs, or other actions. Each MP or node may, for example, have the same trigger conditions set for congestion reporting levels. The MPs may also, for example, perform the same specified congestion control actions, if the congestion level has degraded or increased to meet other congestion level or trigger condition. If the performance remains in the same level, no action may be necessarily performed, for example. A few illustrative examples of a number and types of trigger conditions and associated congestion control actions are shown and described, and any trigger conditions and congestion control actions may be performed in an example embodiment.

In an example embodiment, one of the congestion control actions may include performing admission control or changing admission control rules at a node, e.g, to decide whether to admit or forward data frames from one or more requested traffic streams. For example, the performance state or level for the node (or the trigger condition being met) may cause the node to perform the following illustrative admission control. Nodes or stations may request service for a flow via an Association request, or an ADDTS (Add Traffic stream request) to a node or MP. Based on the performance level or state for the node or MP, the stream may be admitted or supported, or may be rejected. For example, for a low congestion performance level, all new traffic streams may be supported; for medium congestion, only high priority requests (e.g., high AC requests) or requests from specific high priority or “preferred” clients are supported; and for a high congestion, no new traffic streams are admitted or supported (e.g., only supported traffic streams where there is a handover to this node or MP). This is merely an example, and other implementations may be performed.

Further, although not shown in FIG. 4A, an “Admission Control Operation” field (e.g., including one or more bits) in frame 400 may be provided to specify an operation mode of the admission control. The operation modes may set MPs to allow all admission requests, or define that MPs shall forward the new requests to one or more upstream MP(s), or to set a MP to allow only the streams that are ongoing, for instance the terminal is making the handover, or set the MP to deny all received admission control requests. In an example embodiment, the admission control operation field may be included as another sub-field within trigger control field 420.

Conditions for degraded and improved performance may also use hysteresis so that each change in congestion level may be determined to be a relevant or relatively significant change before congestion control actions are triggered, for example. By using hysteresis or using a difference between degraded and improved trigger conditions, unnecessary triggering of actions may be avoided for small changes in performance level, according to an example embodiment. A trigger timeout may also be used to reduce potential congestion control action storms, for example.

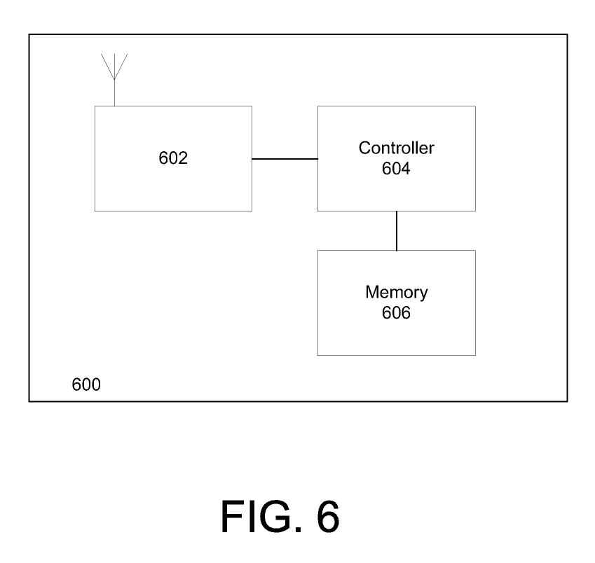

In an example embodiment, each wireless node or mesh point (MP) may include a wireless transceiver, a processor or controller, and memory. FIG. 6 is a block diagram illustrating an example apparatus 600 that may be provided in a wireless node according to an example embodiment. The wireless node, such as a station, AP, MP, etc., may include, for example, a wireless transceiver 602 to transmit and receive signals, a controller 604 to control operation of the station or node and execute instructions or software, and a memory 606 to store data and/or instructions.

Controller 604 may be programmable and capable of executing software or other instructions stored in memory or on other computer media to perform the various tasks and functions described above, such as one or more the tasks or methods described above with reference to FIGS. 1-5.

In an example embodiment, the apparatus or controller 604 may be configured or adapted to determine one or more trigger conditions relating to traffic congestion for one or more performance levels in a wireless network. The controller 604 may be further adapted to associate one or more congestion control actions with each of the one or more performance levels.

In another example embodiment, the controller 604 may be configured or adapted to make a determination that one or more of the trigger conditions for a given one of the performance levels has been met. The controller 604, in this example embodiment may be further adapted to perform at least one of the one or more congestion control actions associated with the given performance level in response to the determination that one or more the trigger conditions has been met.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) or methods described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While a number of aspects and embodiments have been discussed above, it will be appreciated that various modifications, permutations, additions and/or sub-combinations of these aspects and embodiments are possible. It is therefore intended that the following appended claims and claims hereafter introduced are interpreted to include all such modifications, permutations, additions and/or sub-combinations as are within their true spirit and scope.

What is claimed is:

1. A method comprising:
determining one or more trigger conditions relating to traffic congestion for one or more performance levels in a wireless network; and
associating one or more congestion control actions with each of the one or more performance levels.

2. The method of claim 1, further comprising:
making a determination that one or more of the trigger conditions for a given one of the performance levels has been met at a wireless node; and
responsive to the determination, performing at least one of the one or more congestion control actions associated with the given performance level.

3. The method of claim 2, further responsive to the determination that one or more of the trigger conditions for the given one of the performance levels has been met:
initiating a timer with a pre-determined time-out value; and
prior to the timer timing-out, suppressing any additional congestion control actions in response to further determinations that one or more of the trigger conditions has been met.

4. The method of claim 1, further comprising providing a message to one or more wireless nodes in the wireless network, the message including the one of more trigger conditions and the congestion control action associated with each of the one or more performance levels.

5. The method of claim 4, wherein the message to the one or more wireless nodes comprises a congestion control frame.

6. The method of claim 1, wherein the determining and associating are performed for each of a plurality of traffic priorities.

7. The method of claim 1, wherein the determining and associating are performed for each of a plurality of access categories.

8. The method of claim 1, wherein determining the trigger conditions for each performance level comprises determining one or more trigger conditions relating to traffic congestion based on a previous level of performance.

9. The method of claim 1, wherein the trigger conditions for each performance level comprise a first trigger level corresponding with increased congestion and a second trigger level corresponding decreased congestion.

10. The method of claim 1, wherein the one or more congestion control actions for each performance level includes a first one or more congestion control actions associated with increased traffic congestion and a second one or more congestion control actions associated with decreased traffic congestion.

11. The method of claim 1, wherein the one or more trigger conditions comprise one or more quality of service (QoS) metrics.

12. The method of claim 1, wherein the one or more trigger conditions comprise at least one of an average packet error rate, an average packet delay, a number of dropped packets, a number of consecutive frames lost and an average frame loss rate.

13. The method of claim 1, wherein the one more congestion control actions comprise at least one of transmitting a QoS measurement report, transmitting a congestion control request, transmitting a neighborhood congestion control announcement and establishing Enhanced Distributed Channel Access (EDCA) parameters in accordance with a rate control mechanism for a given wireless node.

14. An apparatus comprising:
a controller;
a memory coupled to the controller; and
a wireless transceiver coupled to the controller;
the apparatus being adapted to receive a message, wherein the message:
defines one or more trigger conditions relating to traffic congestion for one or more performance levels for the apparatus in a wireless network; and
associates one or more congestion control actions for the apparatus with each of the one or more performance levels.

15. The apparatus of claim 14, the apparatus being further adapted to:
determine that one or more of the trigger conditions for a given one of the performance levels has been met at the apparatus; and
responsive to the determination, perform at least one of the one or more congestion control actions associated with the given performance level.

16. The apparatus of claim 14, wherein (i) the one or more trigger conditions are respectively determined for and (ii) the one or more congestion control actions are respectively associated with a plurality of traffic priorities or access categories.

17. The apparatus of claim 14, wherein the trigger conditions for each performance level comprise one or more trigger conditions relating to traffic congestion based on a previous level of performance.

18. The apparatus of claim 14, wherein the trigger conditions for each performance level comprise a first trigger level for increased congestion and a second trigger level for decreased congestion.

19. The apparatus of claim 14, wherein the one or more congestion control actions for each performance level includes one or more congestion control actions associated with increased traffic congestion and one or more congestion control actions associated with decreased traffic congestion.

20. The apparatus of claim 14, wherein the one or more trigger conditions comprise one or more quality of service (QoS) metrics.

21. The apparatus of claim 14, the apparatus being further adapted to:
periodically measure the one or more QoS metrics associated with the one or more trigger conditions;
compare the measured QoS metrics with the one or more trigger conditions; and
in the event the measured QoS metrics meet one or more of the trigger conditions, perform at least one of the one or more congestion control actions associated with the one more trigger conditions met by the measured QoS metrics.

22. The apparatus of claim 14, wherein the one more congestion control actions comprise at least one of transmitting a QoS measurement report, transmitting a congestion control request, transmitting a neighborhood congestion control announcement and establishing Enhanced Distributed Channel Access (EDCA) parameters in accordance with a rate control mechanism for a given wireless node.

23. The apparatus of claim 14 wherein the message includes an Admission Control Operation field to specify an operation mode for admission control of the apparatus.

24. A wireless network comprising:
a plurality of communicatively coupled wireless nodes, wherein a first wireless node of the plurality of wireless nodes is adapted to provide a message to a second wireless node of the plurality of wireless nodes, wherein the message:
defines one or more trigger conditions relating to traffic congestion for one or more performance levels in the wireless network; and
associates one or more congestion control actions with each of the one or more performance levels.

25. The wireless network of claim 24, wherein the wireless network is a wireless mesh network.

26. The wireless network of claim 24, wherein the wireless network is a wireless network in compliance with at least one of the 802.11k and 802.11s standards.

27. The wireless network of claim 24, wherein the first wireless node provides the message to the second wireless node over a wireless communication link.

28. The wireless network of claim 24, the second wireless node being adapted to periodically monitor one or more performance parameters associated with the one or more trigger conditions.

29. The wireless network of claim 28, wherein the one or more performance parameters comprise one or more Quality of Service metrics.

30. The wireless network of claim 28, the second apparatus being further adapted to:
based on the performance parameters, determine that one or more of the trigger conditions for a given one of the performance levels has been met at the second wireless node; and
responsive to the determination, perform at least one of the one or more congestion control actions associated with the given performance level.

31. The wireless network of claim 24, wherein (i) the one or more trigger conditions are respectively determined for and (ii) the one or more congestion control actions are respectively associated with a plurality of traffic priorities or access categories.

32. The wireless network of claim 24, wherein the trigger conditions for each performance level comprise a first trigger level for increased congestion and a second trigger level for decreased congestion.
